(19) United States
(12) Patent Application Publication
(10) Pub. No.: US 2013/0112409 A1
(43) Pub. Date: May 9, 2013

(54) Proppant particulates and methods of using such particulates in subterranean applications

(71) Applicant: SOLVAY SPECIALTY POLYMERS USA, LLC, Alpharetta, GA (US)

(72) Inventors: Brian BALENO, Alpharetta, GA (US); William W. LOONEY, Sugar Hill, GA (US); Daniel J. IRELAND, Kernersville, NC (US)

(73) Assignee: SOLVAY SPECIALTY POLYMERS USA, LLC, Alpharetta, GA (US)

(21) Appl. No.: 13/667,876

(22) Filed: Nov. 2, 2012

Related U.S. Application Data
(60) Provisional application No. 61/557,120, filed on Nov. 8, 2011.

(51) Int. Cl. C09K 8/80; E21B 43/04; E21B 43/267

(52) U.S. Cl. CPC C09K 8/80; E21B 43/267; E21B 43/04
USPC 166/278; 166/280.2; 507/219; 528/331; 528/125; 528/190; 528/206; 528/391; 528/347

(57) ABSTRACT

The invention pertains to improved proppant particles comprising an aromatic polycondensation polymer having a glass transition temperature (T_{g}) of at least 120° C. when measured according to ASTM 3418 [polymer (P)] and a method of treating a subterranean formation using said proppant particles.

### CROSS REFERENCE TO RELATED APPLICATIONS

This application claims priority to U.S. provisional application No. 61/557,120 filed on Nov. 8, 2011, the whole content of this application being incorporated herein by reference for all purposes.

### TECHNICAL FIELD

The present invention relates to improved particulates and methods of using such particulates in subterranean applications. More particularly, the present invention relates to composite proppant particulates and their use in subterranean applications such as production enhancement and completion.

### BACKGROUND ART

Proppants are used in a variety of operations and treatments performed in oil and gas wells. Such operations and treatments include, but are not limited to, production stimulation operations such as fracturing and well completion operations such as gravel packing.

Hydraulic fracturing is an example of an oil and gas exploitation operation wherein use is made of solid particulates. In such type of operation, a servicing fluid, referred to in the art as a fracturing fluid, comprising a fluid medium and particulates suspended therein, is pumped through a well bore into a subterranean zone at a rate and pressure such that fractures are formed and extended into the subterranean zone. The fracture or fractures may be horizontal or vertical, with the latter usually predominating, and with the tendency toward vertical fractures generally increasing with the depth of the formation being fractured. Generally, fracturing fluids are viscous fluids in the form of gels, emulsions, or foams. The particulate materials used in these operations are often referred to as proppants. The proppant is deposited in the fracture and functions, inter alia, to maintain the integrity of the fracture open while maintaining conductive channels through which produced fluids (oils and gases) can flow upon completion of the fracturing treatment and release of the attendant hydraulic pressure.

Proppant particulates also are used in well completion operations such as gravel packing. Gravel packing treatments are used, inter alia, to reduce the migration of unconsolidated formation particulates into the well bore. In gravel packing operations, proppant particulates, often referred to in the art also as gravel, are carried to a well bore in a subterranean producing zone by a servicing fluid that acts as a gravel carrier fluid. That is, the particulates are suspended in a carrier fluid, which may be and usually is viscosified, and the carrier fluid is pumped into a well bore in which the gravel pack is to be placed. As the particulates are placed in or near the zone, the carrier fluid leaks off into the subterranean zone and/or is returned to the surface. The resultant gravel pack acts as a sort of filter to prevent the production of the formation solids with the produced fluids. Traditional gravel pack operations involve placing a gravel pack screen in the well bore before packing the surrounding annulus between the screen and the well bore with gravel. The gravel pack screen is generally a filter assembly used to support and retain the gravel placed during the gravel pack operation. A wide range of sizes and screen configurations is available to suit the characteristics of a well bore, the production fluid, and any particulates in the subterranean formation. Gravel packs are used, among other reasons, to stabilize the formation while causing minimal impairment to well productivity.

Also, as more wells are being drilled in deep water and in high temperature zones, gravel packing in long, open horizontal well bores is becoming more prevalent. Completion operations in these wells generally involve the use of reduced-specific gravity particulates that are resistant to degradation in the presence of hostile conditions such as high temperatures and subterranean treatment chemicals. Using lightweight particulates may enhance the complete packing of the well bore annulus between the well bore and the sand screens, and possibly minimize the potential of particulate settling, leaving behind void spaces on top of the gravel pack. Void spaces on top of a gravel pack may be problematic as formation sand or fines often fill such voids during production, which may result in a significant reduction of produced fluids from the well. Erosion of the screen could also occur at a particular location where production flow rate is concentrated at one point on the screen, which in turn allows the gravel or formation materials to produce along with the production fluids.

In some situations, hydraulic fracturing and gravel packing operations may be combined into a single treatment. Such treatments are often referred to as “frac pack” operations. In some cases, the treatments are completed with a gravel pack screen assembly in place with the hydraulic fracturing treatment being pumped through the annular space between the casing and screen. In this situation, the hydraulic fracturing treatment ends in a screen-out condition, creating an annular gravel pack between the screen and casing. In other cases, the fracturing treatment may be performed prior to installing the screen and placing a gravel pack.

Traditional high-strength particulates used in fracturing applications often exhibit too high of a specific gravity to be suspended in lower viscosity fluids. Lower viscosity fluids are desirable because the viscosifiers and crosslinkers used to create them are often expensive. Moreover, viscosifier tends to build up on the walls of the formation in the form of a filter cake that may black the production of fluids once it is desirable to place the formation on production. Moreover, residue of viscosifiers used in subterranean applications often remains on the particulates transported in the viscosified fluid and may reduce the conductivity of packs made from such particulates. While low specific gravity particulates are suitable for use in lower viscosity fluids, these low specific gravity particulates generally are not able to withstand significant closure stresses over time at elevated subterranean temperatures. Examples of such particulates include walnut hulls and thermoplastic materials, including polyolefins, which nevertheless tend to soften and deform under stress when exposed to temperatures above about 65° F. (around 150° F.).

Within this scenario, US 2006260811 (HALLIBURTON ENERGY SERV INC) Nov. 23, 2006 discloses lightweight composite particulates and their use in subterranean applications such as production enhancement and completion made from a homogenous mixture of polyethylene terephthalate (PET) and a filler material. Nevertheless, PET is known as possessing a glass transition temperature of about 70° C. and a heat deflection temperature under a load of 1.82 MPa of 80° C., which features still lead to significant softening and possible deformation at higher operating temperature like those routinely encountered in well bore operations.

Similarly, US 2010204070 Aug. 12, 2010 discloses composite propping agents of low density and high mechanical strength made from mixtures of thermoplastic material and precipitated silica filler. The thermoplastic material is advantageously a polyamide, aliphatic or semi-aromatic, with those including polyamide 6 motifs being preferred; all exemplified embodiments are based on polyamide 6,6, material which is known to possess a T_{g} of around 50° C., which feature, as above mentioned, leads to significant softening and possible deformation at high operating temperature like those routinely encountered in well bore operations. Further, aliphatic polyamides are known to possibly undergo moisture-caused degradation, which might significantly affect behaviour of proppants made from the same in humid environments such as subterranean formations.

### SUMMARY OF THE INVENTION

The present invention thus relates to improved proppant particulates and methods of using such particulates in subterranean applications. More particularly, the present invention relates to proppant particulates comprising at least one aromatic polycondensation polymer having a glass transition temperature (T_{g}) of at least 120° C. when measured according to ASTM 3418 and/or having a heat deflection temperature (HDT) of above 85° C. under a load of 1.82 MPa when measured according to ASTM D648 [polymer (P)], and their use in subterranean applications such as production enhancement and completion.

The Applicant has found that the aromatic character of polymer (P) coupled with its high temperature resistance, as provided by values of T_{g} exceeding 120° C. or of HDT exceeding 85° C. are key parameter to deliver proppant materials possessing adequate compression strength, superior mechanical properties retention in humid environments, and outstanding chemical resistance for reliably behaving in subterranean formations, in contact with organic or other aggressive fluids at temperatures often approaching 100° C. or even beyond.

One embodiment of the present invention provides a method of forming a particulate composite suitable for use as proppant in a subterranean operation comprising the steps of forming a polymer (P) as above detailed and a filler material; and of forming the mixture into proppant particulates suitable for use in a subterranean environment.

Another embodiment of the present invention provides a method of treating a subterranean formation comprising the steps of providing a servicing fluid comprising a fluid component and proppant particulates as above detailed; placing the servicing fluid into the subterranean formation at a pressure sufficient to create or enhance at least one fracture therein.

Another embodiment of the present invention provides a method of fracturing a subterranean formation comprising the steps of providing a fracturing fluid comprising a fluid component and proppant particulates as above detailed; placing the fracturing fluid into the subterranean formation at a pressure sufficient to create or enhance at least one fracture therein.

Another embodiment of the present invention provides a method of installing a gravel pack in or neighbouring a chosen zone in a subterranean formation comprising the steps of providing a gravel pack fluid comprising a fluid component and proppant particulates as above detailed; and, introducing the gravel pack composition to the well bore such that the particulates form a gravel pack substantially adjacent to the chosen zone in the subterranean formation.

Other and further features and advantages of the present invention will be readily apparent to those skilled in the art upon a reading of the description of preferred embodiments that follows.

### DESCRIPTION OF EMBODIMENTS OF THE INVENTION

The composite proppant particulates of the present invention are lightweight and high compression strength, at least up to temperature of around 100° C., and are able to withstand humid and high temperature conditions, as well as contact with organic fluids or other aggressive chemicals generally encountered in subterranean formation well bores exploitation.

As said, it is essential for polymer (P) to possess a glass transition temperature (T_{g}) of above 120° C., when measured according to ASTM 3418.

The Applicant has found that materials not complying with such requirement, even if compounded with high loads of reinforcing fillers, are unable to provide particulate proppants possessing required compression strength at high temperatures, i.e. temperatures possibly exceeding 100° C., like those encountered in subterranean formation fracturing and exploitation.

Behaviour of proppants in subterranean formation fracturing and exploitation can be advantageously assessed by notably determining compression strength on lab-scale specimens at different temperatures, being understood that specimens maintaining outstanding compression strengths at temperature of 100° C. or above are expected not to undergo any critical deformation or failure during subterranean formation fracturing and completion.

Further, the polymer (P) of the invention has, in addition or as an alternative to the T_{g} requirement, a heat deflection temperature (HDT, herein below) of above 85° C. under a load of 1.82 MPa when measured according to ASTM D648.

Actually, certain polymers (P) might not have detectable T_{g}; in such a case, HDT can be suitably used for have an indication of the upper temperature at which structural resistance of the material begins to decrease.

Heat deflection temperature (HDT) values of polymer (P) can be determined according to ASTM D648, Method A, using a span of 4 inches. The polymer is injection moulded into plaques that are 5 inches long, ½ inch wide, and ⅛ inch thick. The plaques are immersed in a suitable liquid heat-transfer medium, such as oil, during the HDT test. Dow Corning 710 silicone oil, for example, can be used.

Suitable polymers (P) may have a completely amorphous structure, a partially or completely crystalline structure, or anything in between. Upon heating, these suitable thermoplastic polymers can melt, becoming sufficiently free flowing to permit processing using standard techniques (molding, extrusion, etc.). In certain embodiments, both amorphous and at least partially crystalline polymers (P) may be used.

Polymers (P) suitable for use in the present invention include, but are not limited to, aromatic polyimides (PI), in particular polyester-imides (PEI) and polyamide-imides (PAI), polyaryletherketones (PAEK), such as polyetheretherketone (PEEK) and polyetherketoneketone (PEKK), liquid crystal polymers (LCP), semi-aromatic polyamides (PA), including polyamides derived from aromatic dicarboxylic acids (PPA) and polyamides derived from aromatic diamines (PXA), and aromatic sulfone polymers (SP).

The skilled in the art will select among those classes, polymer compositions enabling fulfilment of above mentioned glass transition temperature requirement, i.e. will select monomers compositions and/or other structural parameters of above mentioned polymers (PI), (PEI), (PAI), (PAEK), (PEEK), (PEKK), (LCP), (PA), (PPA), (PXA) and (SP) for satisfying the requirement of having a T_{g} exceeding 120° C.

To the purpose of the present invention, “aromatic polyimide (PI)” is intended to denote any polymer comprising recurring units, more than 50% moles of said recurring units comprising at least one aromatic ring and at least one imide group, as such (formula 1A) or in its amic acid form (formula 1B) [recurring units (R_{PI})]:

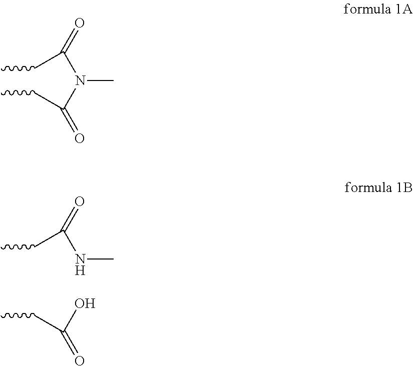

The imide group, as such or in its corresponding amic acid form, is advantageously linked to an aromatic ring, as illustrated below:

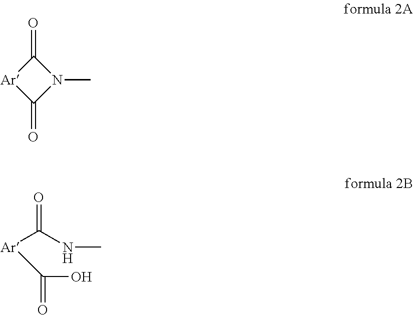

whereas Ar′ denotes a moiety containing at least one aromatic ring.

The imide group is advantageously present as condensed aromatic system, yielding a five- or six-membered heteroaromatic ring, such as, for instance, with benzene (phthalimide-type structure, formula 3) and naphthalene (naphthalimide-type structure, formula 4).

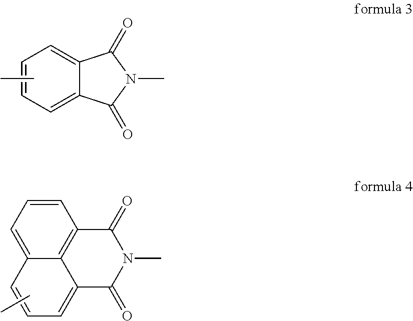

The formulae here below depict examples of recurring units (R_{PI}) (formulae 5A to 5C):

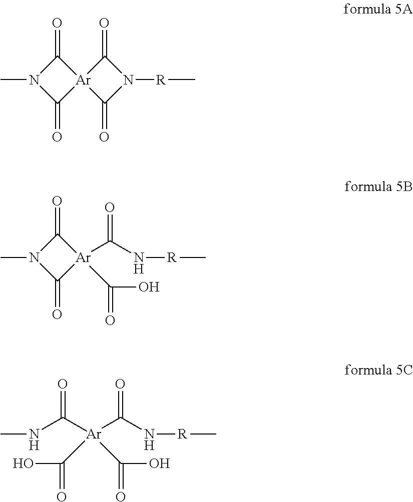

wherein:
Ar represents an aromatic tetravalent group; typically Ar is selected from the group consisting of following structures:

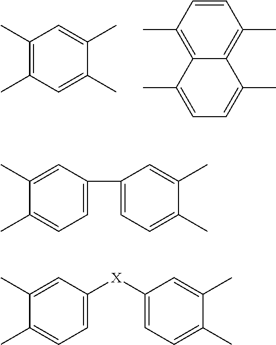

and corresponding optionally substituted structures, with X being —O—, —C(O)—, —CH₂—, —C(CF₃)₂—, —(CF₂)ₙ—, with n being an integer from 1 to 5;
R represents an aromatic divalent group; typically R is selected from the group consisting of following structures:

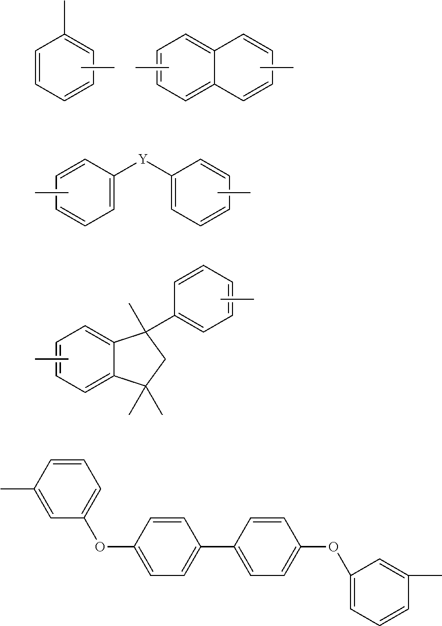

and corresponding optionally substituted structures, with Y being —O—, —S—, —SO₂—, —CH₂—, —C(O)—, —C(CF₃)₂—, —(CF₂)ₙ, n being an integer from 0 to 5.

Polyimides commercialized by DuPont as VESPEL® polyimides or by Mitsui as AURUM® polyimides are suitable for the purpose of the invention, provided that they comply with above mentioned T_{g} and/or HDT requirement.

The recurring units (R_{PI}) of the aromatic polyimide can comprise one or more functional groups other than the imide group, as such and/or in its amic acid form. Non limitative examples of polymers complying with this criterion are aromatic polyetherimides (PEI), aromatic polyesterimides and aromatic polyamide-imides (PAI).

To the purpose of the present invention, “aromatic polyesterimide” is intended to denote any polymer more than 50% moles of the recurring units comprise at least one aromatic ring, at least one imide group, as such and/or in its amic acid form, and at least one ester group [recurring units (R_{PEI})]. Typically, aromatic polyesterimides are made by reacting at least one acid monomer chosen from trimellitic anhydride and trimellitic anhydride monoacid halides with at least one diol, followed by reaction with at lest one diamine.

To the purpose of the present invention, “aromatic polyamide-imide (PAI)” is intended to denote any polymer comprising more than 50% moles of recurring units comprising at least one aromatic ring, at least one imide group, as such and/or in its amic acid form, and at least one amide group which is not included in the amic acid form of an imide group [recurring units (R_{PAI})].

The recurring units (R_{PAI}) are advantageously chosen among:

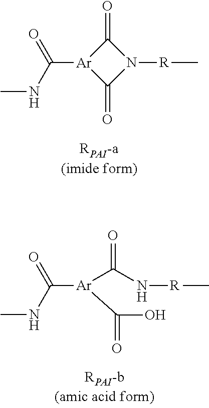

wherein:
Ar is a trivalent aromatic group; typically Ar is selected from the group consisting of following structures:

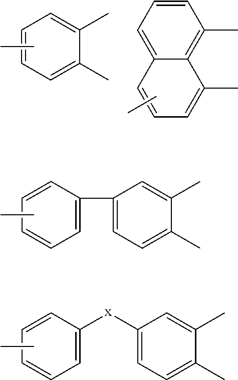

and corresponding optionally substituted structures, with X being —O—, —C(O)—, —CH₂—, —C(CF₃)₂—, —(CF₂)ₙ—, with n being an integer from 1 to 5;
R is a divalent aromatic group; typically R is selected from the group consisting of following structures:

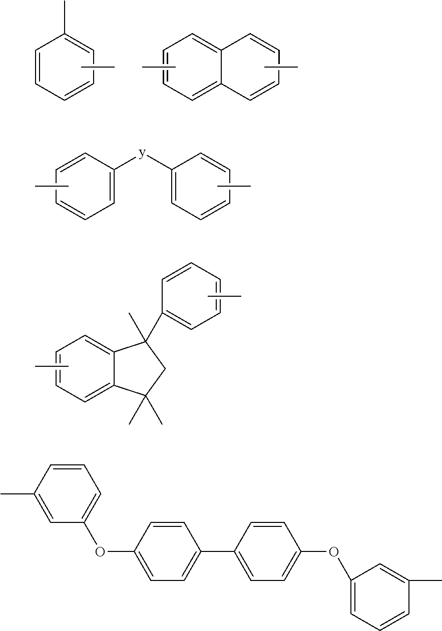

and corresponding optionally substituted structures, with Y being —O—, —S—, —SO₂—, —CH₂—, —C(O)—, —C(CF₃)₂—, —(CF₂)ₙ, n being an integer from 0 to 5.

Preferably, the aromatic polyamide-imide comprises more than 50% of recurring units (R_{PAI}) comprising an imide group in which the imide group is present as such, like in recurring units (R_{PAI}-a), and/or in its amic acid form, like in recurring units (R_{PAI}-b).

Recurring units (R_{PAI}) are preferably chosen from recurring units (l), (m) and (n), in their amide-imide (a) or amide-amic acid (b) forms:

(l)

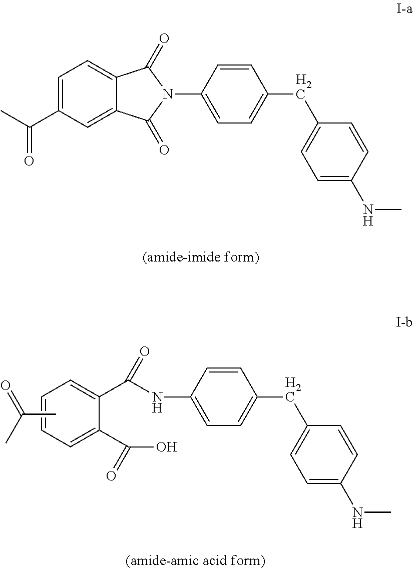

wherein the attachment of the two amide groups to the aromatic ring as shown in (l-b) will be understood to represent the 1,3 and the 1,4 polyamide-amic acid configurations;
(m)

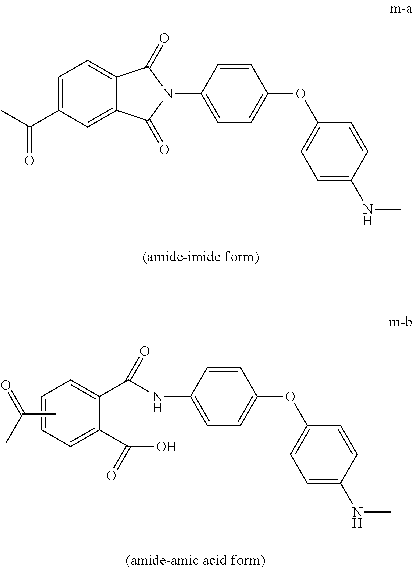

wherein the attachment of the two amide groups to the aromatic ring as shown in (m-b) will be understood to represent the 1,3 and the 1,4 polyamide-amic acid configurations; and
(n)

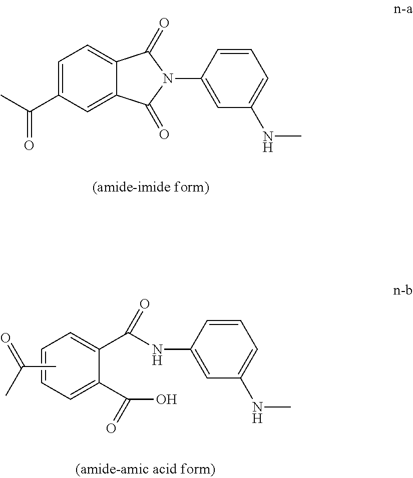

wherein the attachment of the two amide groups to the aromatic ring as shown in (n-b) will be understood to represent the 1,3 and the 1,4 polyamide-amic acid configurations.

Very preferably, the aromatic polyamide-imide comprises more than 90% moles of recurring units (R_{PAI}). Still more preferably, it contains no recurring unit other than recurring units (R_{PAI}). Polymers commercialized by Solvay Advanced Polymers, L.L.C., as TORLON® polyamide-imides comply with this criterion.

For the purpose of the invention, the term “polyaryletherketone (PAEK)” is intended to denote any polymer, comprising recurring units, more than 50% moles of said recurring units are recurring units (R_{PAEK}) comprising a Ar—C(O)—Ar′ group, with Ar and Ar′, equal to or different from each other, being aromatic groups. The recurring units (R_{PAEK}) are generally selected from the group consisting of formulae (J-A) to (J-O), herein below:

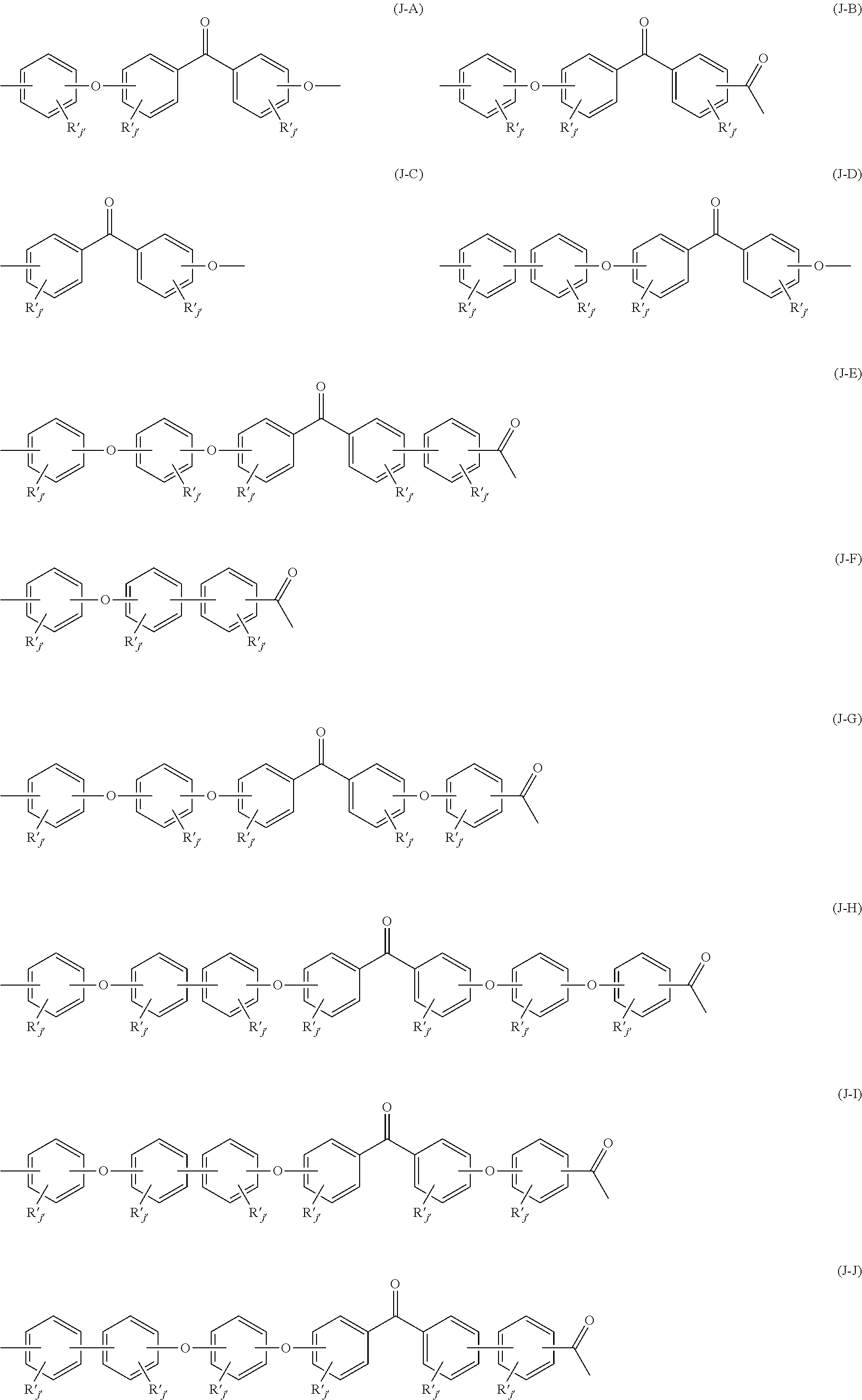

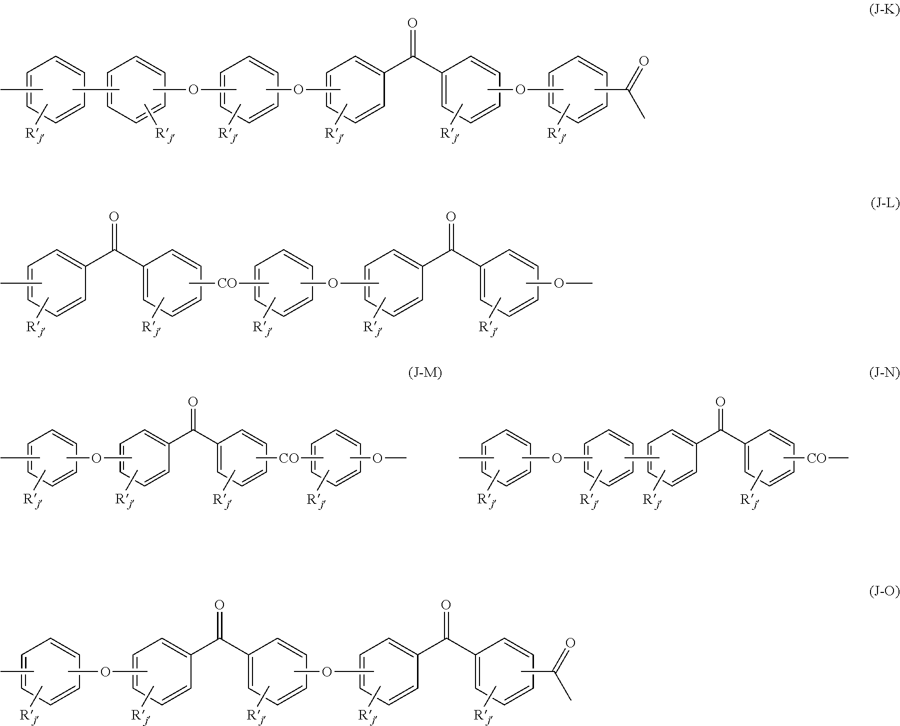

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4.

In recurring unit (R_{PAEK}), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage.

Still, in recurring units (R_{PAEK}), j′ is at each occurrence zero, that is to say that the phenylene moieties have no other substituents than those enabling linkage in the main chain of the polymer.

Preferred recurring units (R_{PAEK}) are thus selected from those of formulae (J′-A) to (J′-O) herein below:

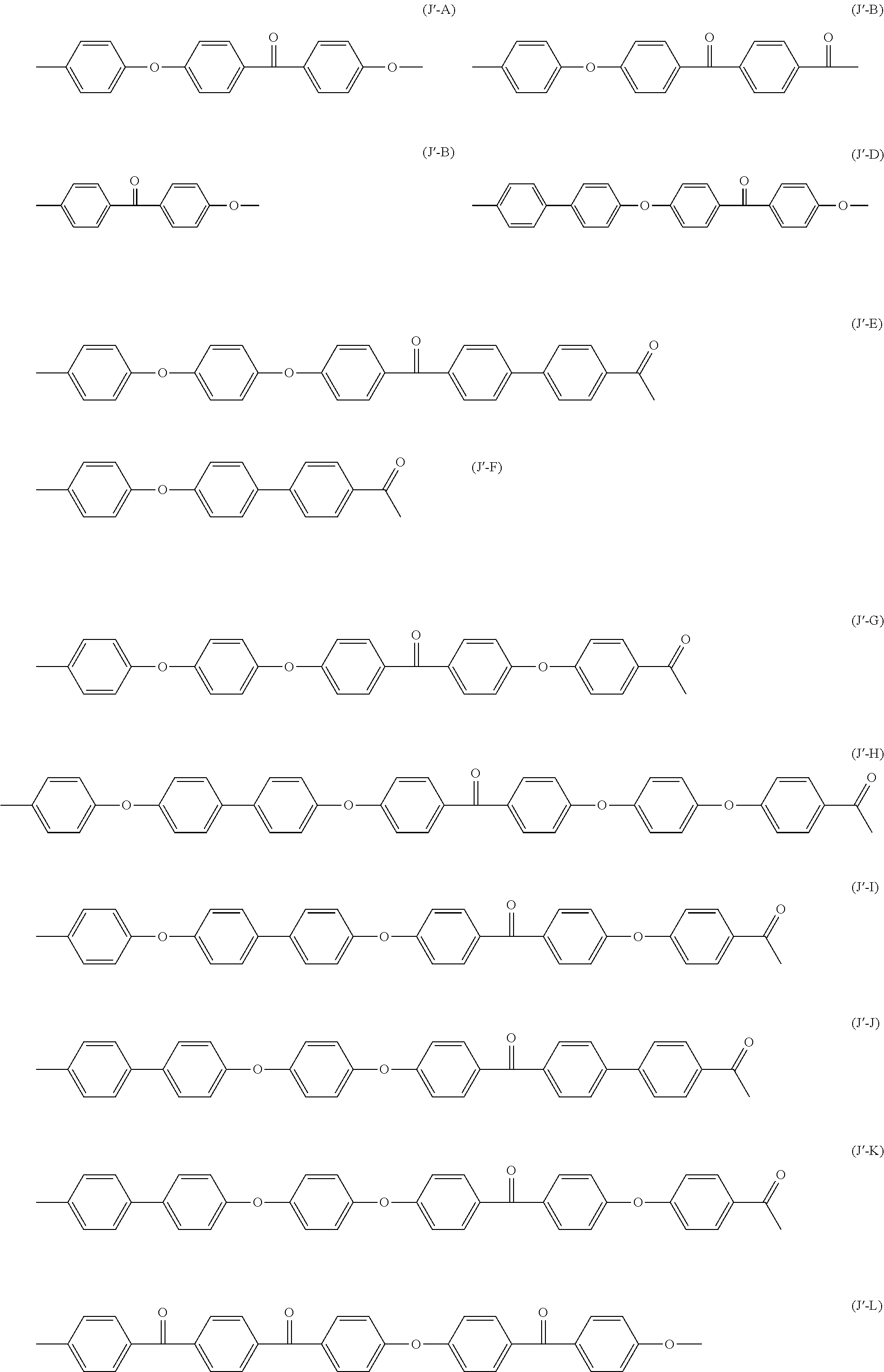

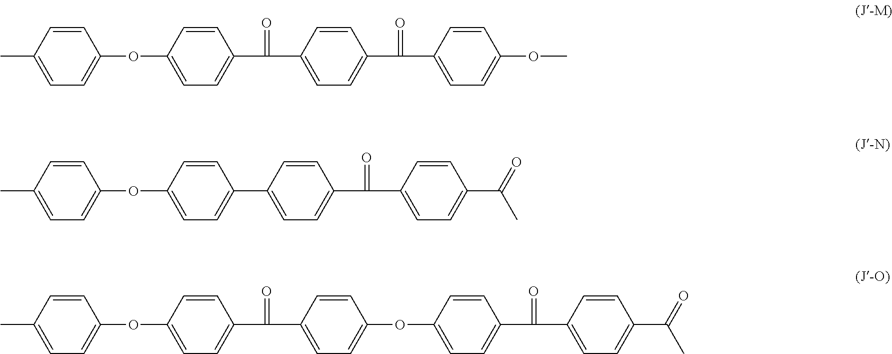

Polyaryletherketones (PAEK) are generally crystalline aromatic polymers, readily available from a variety of commercial sources. The polyaryletherketones (PAEK) have preferably reduced viscosities in the range of from about 0.8 to about 1.8 dl/g as measured in concentrated sulfuric acid at 25° C. and at atmospheric pressure.

Non limitative examples of commercially available polyaryletherketone (PAEK) resins suitable for the invention include the KETASPIRE® polyetheretherketone commercially available from Solvay Advanced Polymers and VICTREX® PEEK polyetheretherketone, from Imperial Chemicals, Inc., which are polymers, the recurring units of which are recurring units (k-c1):

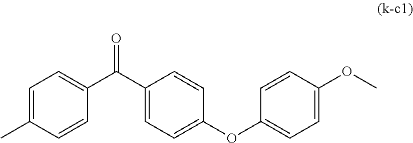

The terms “liquid crystal polymers (LCP)” encompasses notably fully aromatic liquid crystalline polyesters.

Fully aromatic liquid crystalline polyester generally comprise recurring units derived from polycondensation of
an aromatic acid component [monomer (AA)] comprising one or more than one aromatic dicarboxylic acid or derivative thereof, preferably selected from phthalic acids, naphthalene dicarboxylic acids and pyridine dicarboxylic acids, and corresponding substituted counterparts; and
a dihydroxyl component [monomer (BB)] comprising one or more than one di-hydroxyl aromatic derivative or derivative thereof, preferably selected from biphenol, 4,4′-dihydroxy-1,1-biphenyl, and corresponding substituted counterparts;
   and/or from polycondensation of one or more than one aromatic hydroxyl-substituted carboxylic acid or derivatives thereof [monomer (AB)], preferably selected from 4-hydroxybenzoic acid, 6-hydroxy-é-naphthoic acids, and corresponding substituted counterparts,
   being understood that monomers (AB) can be polymerized alone or in combinations with monomers (AA) and (BB), as above detailed.

Fully aromatic liquid crystalline polyesters can be produced in the melt by three main processes:
direct esterification of optionally substituted diphenols with aromatic carboxylic acids in the presence of catalysts such as titanium tetrabutyrate or dibutyl tin diacetate at high temperature;
reaction between phenyl esters of aromatic carboxylic acids with relevant optionally substituted diphenols;
acidolysis of diphenolic acetates with aromatic carboxylic acids.

Non limitative examples of commercially available fully aromatic liquid crystalline polyesters are notably VECTRA® LCP from Hoechst-Celanese, known for possessing T_{g} of 145° C. or above and XYDAR® LCP from Solvay Advanced Polymers, generally characterized by HDT values exceeding 200° C., when determined under a 1.8 MPa load according to ASTM D648.

VECTRA® LCP is typically synthesized from 4-hydrobenzoic acid and 6-hydroxy-2-naphtoic acid; VECTRA® LCP is a polymer the recurring units of which are recurring units (lcp-A) and (lcp-B), typically in a ratio (lcp-A)/(lcp-B) of about 25/75:

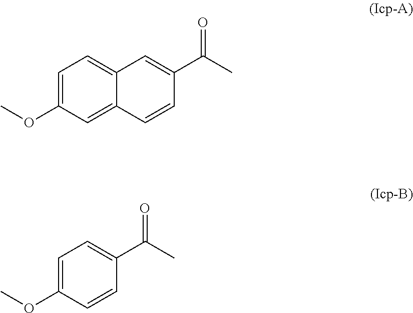

XYDAR® LCP is typically synthesized from 4-hydroxybenzoic acid, 4,4′-dihydroxy-1,1′-biphenyl, and terephthalic acid; the basic structure can be modified by using other monomers such as isophthalic acid or 4-aminobenzoic acid; XYDAR® LCP is generally a polymer the recurring units of which are recurring units (lcp-C), (lcp-D) and (lcp-B), typically in a ratio [(lcp-C)+(lcp-D)]/(lcp-B) of about ½:

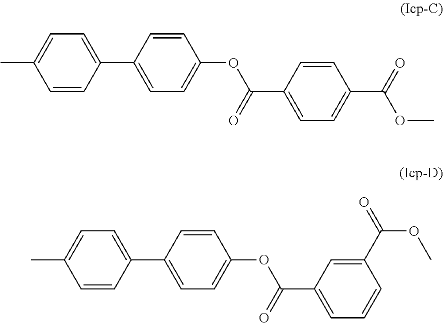

For the purpose of the invention, the expression “aromatic sulfone polymer (SP)” is intended to denote any polymer, at least 50% moles of the recurring units thereof comprise at least one group of formula (SP) [recurring units (R_{SP})]:

—Ar—SO₂—Ar′— formula (SP)

with Ar and Ar′, equal to or different from each other, being aromatic groups. Recurring units (R_{SP}) generally comply with formula:

—Ar¹-(T′-Ar²)ₙ—O—Ar³—SO₂—[Ar⁴-(T-Ar²)ₙ—SO₂]ₘ—Ar⁵—O—

wherein:
Ar¹, Ar³, Ar³, Ar⁴, and Ar⁵, equal to or different from each other and at each occurrence, are independently a aromatic mono- or polynuclear group;
T and T′, equal to or different from each other and at each occurrence, is independently a bond or a divalent group optionally comprising one or more than one heteroatom; preferably T′ is selected from the group consisting of a bond, —CH₂—, —C(O)—, —C(CH₃)₂—, —C(CF₃)₂—, —C(═CCl₂)—, —SO₂—, —C(CH₃)(CH₂CH₂COOH)—, and a group of formula:

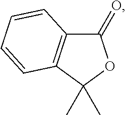

and
preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

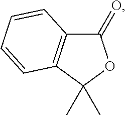

and
n and m, equal to or different from each other, are independently zero or an integer of 1 to 5.

Recurring units (R_{SP}) can be notably selected from the group consisting of those of formulae (S-A) to (S-D) herein below:

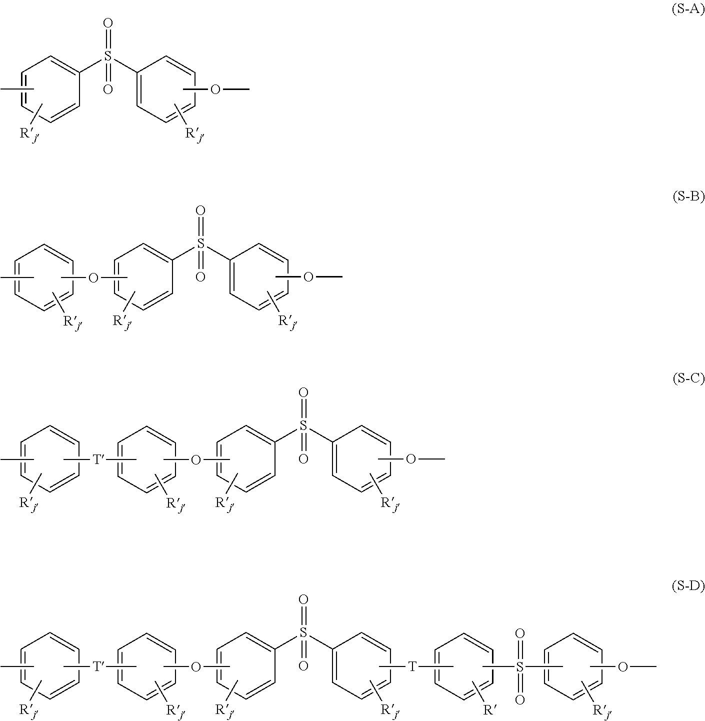

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4;
T and T′, equal to or different from each other are a bond or a divalent group optionally comprising one or more than one heteroatom; preferably T′ is selected from the group consisting of a bond, —CH₂—, —C(O)—, —C(CH₃)₂—, —C(CF₃)₂—, —C(═CCl₂)—, —C(CH₃)(CH₂CH₂COOH)—, —SO₂—, and a group of formula:

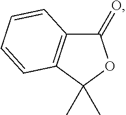

and
preferably T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

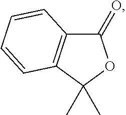

and
The aromatic sulfone polymer (P) has typically a glass transition temperature of advantageously at least 150° C., preferably at least 160° C., more preferably at least 175° C.

In a first preferred embodiment of the invention, at least 50% moles of the recurring units of aromatic sulfone polymer (SP) are recurring units (R_{SP-1}), in their imide form (R_{SP-1}-A) and/or amic acid forms [(R_{SP-1}-B) and (R_{SP-1}-C)]:

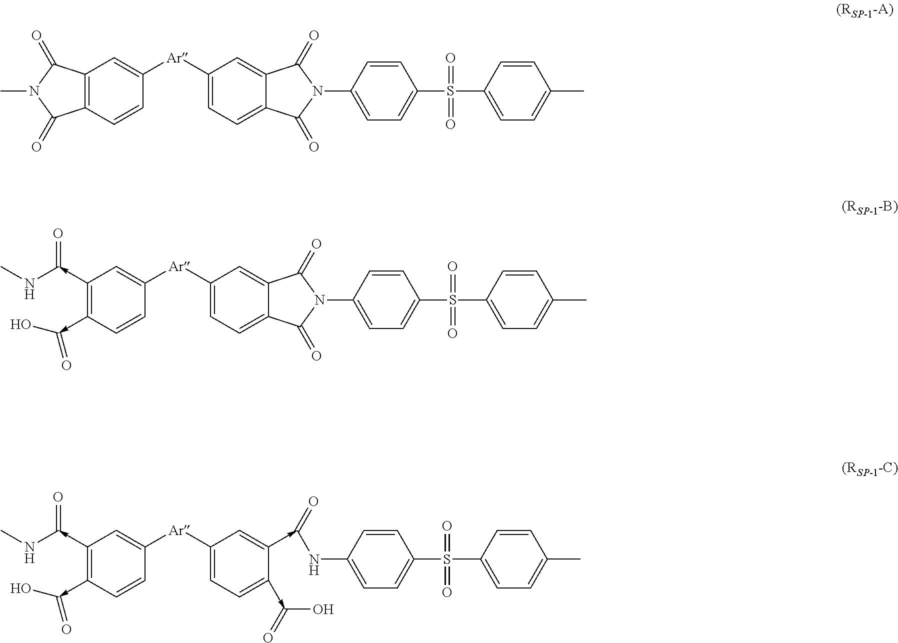

wherein:
the → denotes isomerism so that in any recurring unit the groups to which the arrows point may exist as shown or in an interchanged position;
Ar″ is selected from the group consisting of:

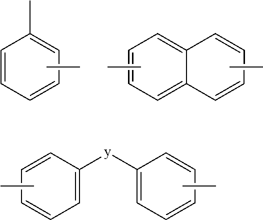

and corresponding optionally substituted structures, with Y being —O—, —C(O)—, —(CH₂)ₙ—, —C(CF₃)₂—, —(CF₂)ₙ—, with n being an integer from 1 to 5, and mixtures thereof.

In a second preferred embodiment of the invention, at least 50% moles of the recurring units of aromatic sulfone polymer (SP) are recurring units (R_{SP-2}) and/or recurring units (R_{SP-3}):

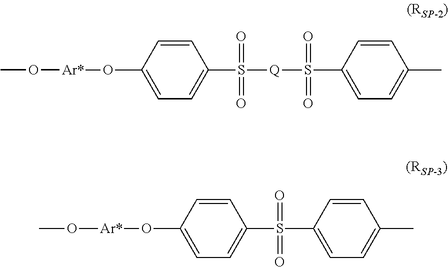

wherein:
Q and Ar*, equal or different from each other and at each occurrence, are independently a divalent aromatic group; preferably Ar* and Q equal or different from each other and at each occurrence, are independently selected from the group consisting of the following structures:

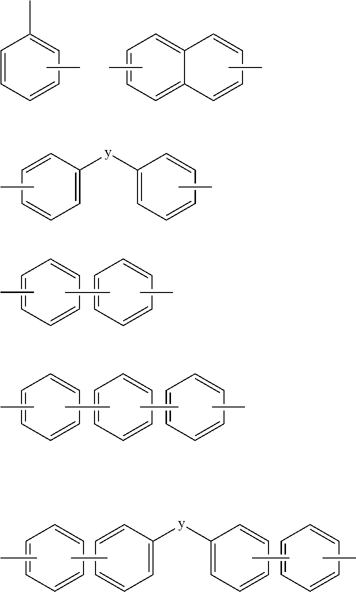

and corresponding optionally substituted structures, with Y being —O—, —CH═CH—, —C≡C—, —S—, —C(O)—, —(CH₂)ₙ—, —C(CF₃)₂—, —C(CH₃)₂—, —SO₂—, —(CF₂)ₙ—, with n being an integer from 1 to 5 and mixtures thereof; and mixtures thereof.

Recurring units (R_{SP-2}) are preferably selected from the group consisting of:

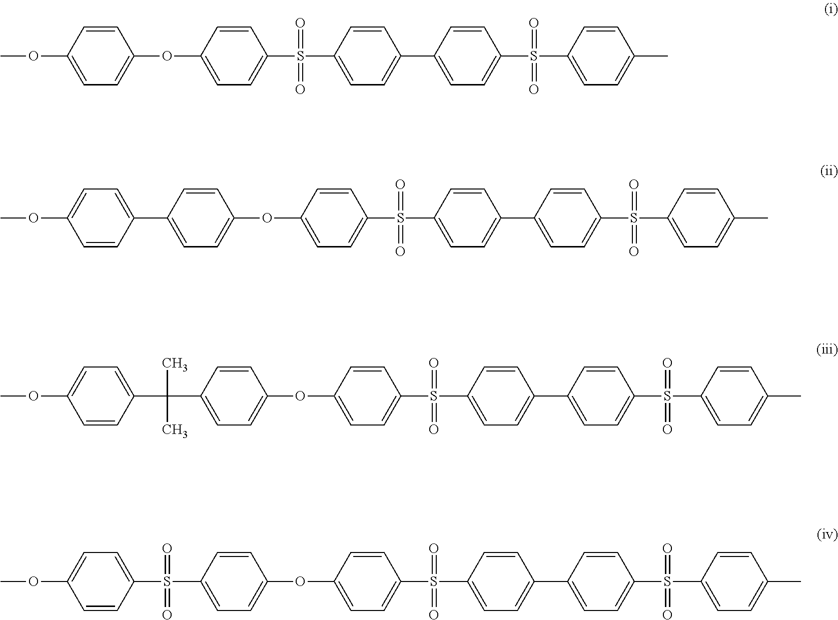

and mixtures thereof.

Recurring units (R_{SP-3}) are preferably selected from the group consisting of:

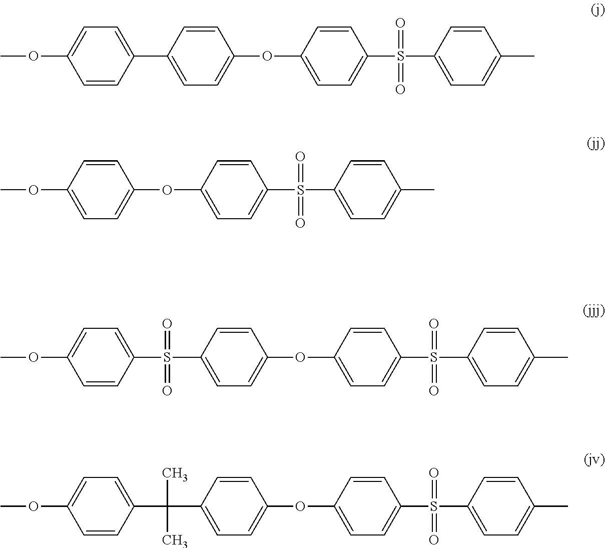

and mixtures thereof.

Aromatic sulfone polymer (SP) according to the second preferred embodiment of the invention comprises at least 50% moles, preferably 70% moles, more preferably 75% moles of recurring units (R_{SP-2}) and/or (R_{SP-3}), still more preferably, it contains no recurring unit other than recurring units (R_{SP-2}) and/or (R_{SP-3}).

Good results were obtained with aromatic sulfone polymer (P) the recurring units of which are recurring units (ii) (polybiphenyldisulfone, herein after), with aromatic sulfone polymer (P) the recurring units of which are recurring units (j) (polyphenylsulfone, hereinafter), with aromatic sulfone polymer (P) the recurring units of which are recurring units (jj) (polyetherethersulfone, hereinafter), with aromatic sulfone polymer (P) the recurring units of which are recurring units (jjj) and, optionally in addition, recurring units (jj) (polyethersulfone, hereinafter), and with aromatic sulfone polymer (P) the recurring units of which are recurring units (jv) (polysulfone, hereinafter).

Polyphenylsulfone is notably available as RADEL® R PPSU from Solvay Advanced Polymers, L.L.C. Polysulfone is notably available as UDEL® PSF from Solvay Advanced Polymers, L.L.C. Polyethersulfone is notably available as RADEL® A PES from Solvay Advanced Polymers, L.L.C.

For the purpose of the present invention, the expression “aromatic polyamide polymer (PA)” is intended to denote a polyamide that comprises more than 35 mol %, preferably more than 45 mol %, more preferably more than 55 mol %, still more preferably more than 65 mol % and most preferably more than 75 mol % of aromatic recurring units comprising at least one amide group [recurring units (R_{PA})].

For the purpose of the present invention, the expression “aromatic” with reference to recurring units (R_{PA}) is intended to mean that said recurring units comprise at least one aromatic group. The recurring units (R_{PA}) may be formed by the polycondensation of at least one aromatic dicarboxylic acid with a diamine or by the polycondensation of at least one dicarboxylic acid with an aromatic diamine, or by the polycondensation of an aromatic amino-acid.

According to a first embodiment, the recurring units (R_{PA}) are recurring units R_{PPA}) deriving from polycondensation reaction of:
(i-1) a dicarboxylic acid component [acid component (AA)], wherein said acid component (AA) comprises at least one aromatic dicarboxylic acid or derivative thereof [acid (AR)]; and
(i-2) a diamine component [amine component (NN)] comprising at least one aliphatic alkylene-diamine [amine (NN)], and/or from polycondensation reaction of:
(i-3) an aromatic aminoacid component [aminoacid component (ArN)], comprising at least one aromatic carboxylic acid comprising at least one amino group.

Recurring units (R_{PPA}) can thus be obtained from polycondensation of an acid component (AA), a diamine component (NN), optionally in the presence of an aminoacid component (ArN), or can be obtained from polycondensation of an aminoacid component (ArN), being understood that additional components, including end-capping, branch-point monomers or other non-aromatic monomers can be further used.

The acid component (AA) may comprise in addition to said at least one aromatic dicarboxylic acid [acid (AR)], one or more than one non-aromatic dicarboxylic acid [acid (AL)].

Non limitative examples of acids (AR) are notably phthalic acids [acids (PA)], including isophthalic acid (IA), terephthalic acid (TA) and orthophthalic acid (OA), and substituted counterparts, including 5-ter-butylisophthalic acid, 2-phenoxy-terephthalic acid; and other aromatic dicarboxylic acids, including 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, the 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid, 1,2-naphthalene dicarboxylic acid, biphenyldicarboxylic acids of formulae:

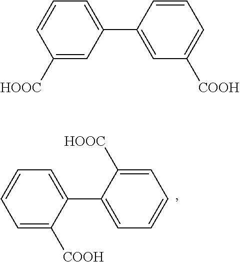 [SMILES: O=C(O)c1cccc(-c2cccc(C(=O)O)c2)c1 ; O=C(O)c1ccccc1-c1ccccc1C(=O)O]

diphenylmethane dicarboxylic acids of formulae:

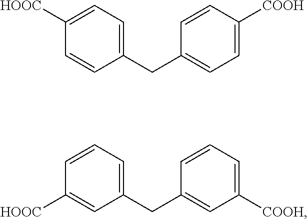 [SMILES: O=C(O)c1ccc(Cc2ccc(C(=O)O)cc2)cc1 ; O=C(O)c1cccc(Cc2cccc(C(=O)O)c2)c1]

4,4′-oxybis(benzoic acid) of formula:

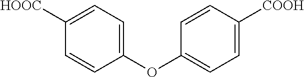 [SMILES: O=C(O)c1ccc(Oc2ccc(C(=O)O)cc2)cc1]

Among acids (AL), mention can be notably made of oxalic acid (HOOC—COOH), malonic acid (HOOC—CH₂—COOH), adipic acid [HOOC—(CH₂)₄—COOH], succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tetradecandioic acid [HOOC—(CH₂)₁₁—COOH], cis- and/or trans-cyclohexane-1,4-dicarboxylic acid and cis- and/or trans-cyclohexane-1,3-dicarboxylic acid (CHDA).

According to preferred embodiments of the present invention, the acid component (AA) comprises advantageously at least one phthalic acid selected from the group consisting of isophthalic acid (IA), and terephthalic acid (TA). Isophthalic acid and terephthalic acid can be used alone or in combination. The phthalic acid is preferably terephthalic acid, optionally in combination with isophthalic acid.

The acid component (AA) according to this preferred embodiment comprises said phthalic acid in an amount of at least 35% moles, preferably at least 50% moles, based on the all components of the acid component (AA).

The diamine component [amine component (NN)] comprises at least one aliphatic alkylene-diamine.

Said aliphatic alkylene-diamine are typically aliphatic alkylene diamines having 2 to 18 carbon atoms.

Said aliphatic alkylene diamine is advantageously selected from the group consisting of 1,2-diaminoethane, 1,2-diaminopropane, propylene-1,3-diamine, 1,3-diaminobutane, 1,4-diaminobutane, 1,5-diaminopentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,5-diamino-2-methylpentane (2-MPMD), 1,3-pentanediamine (DAMP), 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1,8-diamino-1,3-dimethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1,9-diamino-5-methylnonane, 1,11-diaminoundecane and 1,12-diaminododecane.

The amine component (NN) preferably comprises at least one diamine selected from the group consisting of 1,6-diaminohexane, 1,8-diamino-octane, 1,10-diaminodecane, 1,12-diaminododecane and mixtures thereof. More preferably, the amine component (NN) comprises at least one diamine selected from the group consisting of 1,6-diaminohexane, 1,10-diaminodecane and mixtures thereof.

In addition to the at least one aliphatic alkylene-diamine, the amine component (NN) can further comprise at least one diamine different from said aliphatic alkylene-diamine.

Said additional diamine can be notably an aromatic diamine (NN_{Ar}), preferably selected from the group consisting of m-phenylene diamine (MPD), p-phenylene diamine (PPD), 3,4′-diaminodiphenyl ether (3,4′-ODA), 4,4′-diaminodiphenyl ether (4,4′-ODA), m-xylylenediamine (MXDA), and p-xylylenediamine (PXDA), as shown below:

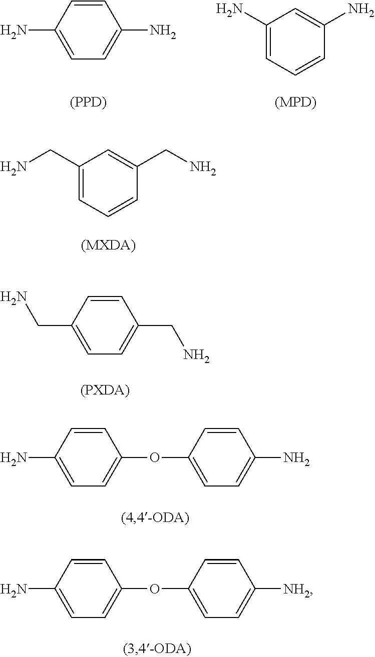

or can be notably a cycloaliphatic diamine (NN_{Cy}), preferably selected from the group consisting of isophoronediamine (also known as 5-amino-(1-aminomethyl)-1,3,3-trimethylcyclohexane), 1,3-cyclohexanebis(methylamine) (1,3-BAMC), 1,4-cyclohexanebis(methylamine) (1,4-BAMC), 4,4-diaminodicyclohexylmethane (PACM), and bis(4-amino-3-methylcyclohexyl)methane.

The aromatic aminoacid component (ArN) comprises at least one aromatic aminoacid or derivative thereof; said aromatic amino-acid is generally selected from the group consisting of 4-(aminomethyl)benzoic acid and 4-aminobenzoic acid.

The aromatic polyamide polymer (PA) of this first embodiment can also comprise, in addition to recurring units derived from polycondensation of monomers listed under paragraphs (i-1) [acid component (AA)], (i-2) [amine component (NN)] and (i-3) [aminoacid component (ArN)], recurring units derived from polycondensation of an aliphatic or cycloaliphatic aminoacid component, including notably 4-aminocyclohexanecarboxylic acid (cis or trans), 4-(aminomethyl)-cyclohexanecarboxylic acid (cis or trans).

The skilled in the art will select among all possible monomer components, appropriate combinations for obtaining polyamides (PPA) fulfilling above mentioned T_{g} requirement.

For an aromatic polyamide (PA) comprising recurring units (R_{PPA}), also referred to as polyamide (PPA), as above defined, preferred combinations which would provide T_{g} above 120° C., are notably the following:
polyamides, as above detailed, obtained by polycondensation of an acid component (AA) and an amine component (NN), wherein the acid component (AA) comprises acids (PA), in particular acid (TA) and acid (OA), alone or in combination, and is substantially free from acid (AL), as above detailed, and wherein the amine component (NN) consists of one or more than one aliphatic alkylene diamine comprising 6 carbon atoms or less;
polyamides, as above detailed, wherein the acid component (AA) comprises at least one naphthalene dicarboxylic acid, and wherein the amount of acid(s) (AL) is less than 10% moles, with respect to all acids of the acid component (AA);
polyamides, as above detailed, wherein the amine component (NN) comprises at least one aromatic diamine (NN_{Ar}), preferably selected from the group consisting of m-phenylene diamine (MPD), p-phenylene diamine (PPD), 3,4′-diaminodiphenyl ether (3,4′-ODA), 4,4′-diaminodiphenyl ether (4,4′-ODA), m-xylylenediamine (MXDA), and p-xylylenediamine (PXDA), said aromatic diamine (NN_{Ar}) being comprised in an amount of at least 5% moles, with respect to all amines of the amine component (NN);
polyamides, as above detailed, wherein the amine component (NN) comprises at least one cycloaliphatic diamine (NN_{Cy}), preferably selected from 1,3-BAMC, 1,4-BAMC, PACM, bis(4-amino-3-methylcyclohexyl)methane, isophoronediamine, said cycloaliphatic diamine (NN_{Cy}) being comprised in an amount of at least 5% moles, with respect to all amines of the amine component (NN);
polyamides, as above detailed, wherein the amine component (NN) comprises at least one aliphatic alkylene-diamine selected from the group consisting of 1,2-diamino-1-butylethane, 1,5-diamino-2-methylpentane (2-MPMD), and 1,3-pentanediamine (DAMP), in an amount of at least 5% moles, with respect to all amines of the amine component (NN).

According to a second embodiment, the recurring units (R_{PA}) are recurring units (R_{PXA}) deriving from polycondensation reaction of:
(i-1) a dicarboxylic acid component [acid component (AA′)], wherein said acid component (AA′) comprises at least one non-aromatic dicarboxylic acid or derivative thereof [acid (AL′)]; and
(i-2) a diamine component [amine component (NN′)] comprising at least one aromatic diamine [amine (NN_{Ar})].

The acid component (AA′) may comprise in addition to said at least one non-aromatic dicarboxylic acid [acid (AL′)], one or more than one aromatic dicarboxylic acid [acid (AR′)].

Acids (AL′) and acids (AR′) suitable for being used in the aromatic polyamides of this second embodiment are the same as those above described respectively as acids (AL) and acids (AR) herein above, and are hereby described with reference to what specified above.

The diamine component [amine component (NN′)] comprises at least one aromatic diamine [amine (NN_{Ar})]. Said amine (NN_{Ar}) is preferably selected from the group consisting of m-phenylene diamine (MPD), p-phenylene diamine (PPD), 3,4′-diaminodiphenyl ether (3,4′-ODA), 4,4′-diaminodiphenyl ether (4,4′-ODA), m-xylylenediamine (MXDA), and p-xylylenediamine (PXDA), as shown below:

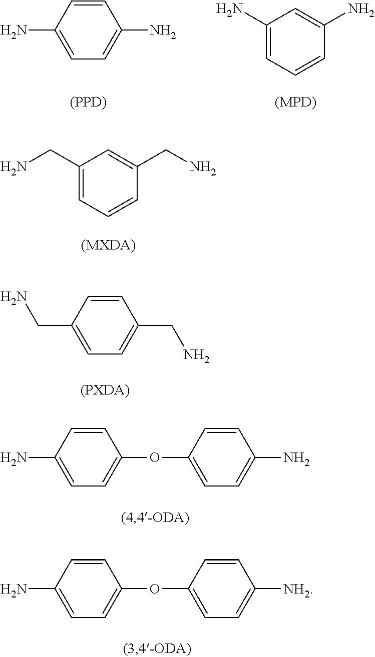

Said amine (NN_{Ar}) is more preferably m-xylylenediamine (MXDA).

The amine component (NN′) can comprise, in addition to said amine (NN_{Ar}), one or more than one non-aromatic diamines [amine (NN_{AL})], preferably selected from the group consisting of aliphatic alkylene-diamines, as above detailed with reference to first embodiment, and cycloaliphatic diamines, said cycloaliphatic diamines being preferably selected from the group consisting of isophoronediamine (also known as 5-amino-(1-aminomethyl)-1,3,3-trimethylcyclohexane), 1,3-cyclohexanebis(methylamine) (1,3-BAMC), 1,4-cyclohexanebis(methylamine) (1,4-BAMC), 4,4-diaminodicyclohexylmethane (PACM), and bis(4-amino-3-methylcyclohexyl)methane.

For an aromatic polyamide (PA) comprising recurring units (R_{PXA}), also referred to as polyamide (PXA), as above defined, preferred combinations which would provide T_{g} above 120° C., are notably the following:
polyamides, as above detailed, obtained by polycondensation of an acid component (AA′) and an amine component (NN′), wherein the amount of amine (NN_{AL}), if present, in the amine component (NN′) is of at most 20% moles, with respect to the total moles of amine component (NN′);
polyamides, as above detailed, wherein the amine component (NN′); comprises at least one cycloaliphatic diamine (NN_{Cy}), preferably selected from 1,3-BAMC, 1,4-BAMC, PACM, bis(4-amino-3-methylcyclohexyl)methane, isophoronediamine, said cycloaliphatic diamine (NN_{Cy}) being comprised in an amount of at least 5% moles, with respect to all amines of the amine component (NN′);
polyamides, as above detailed, wherein the amine component (NN′) comprises at least one aliphatic alkylene-diamine selected from the group consisting of 1,2-diamino-1-butylethane, 1,5-diamino-2-methylpentane (2-MPMD), and 1,3-pentanediamine (DAMP), in an amount of at least 5% moles, with respect to all amines of the amine component (NN′).

The proppant particulates may comprise from about 5 percent to about 70 percent filler material by weight of the overall proppant particulate. The proppant particulates of the present invention will generally have a range of specific gravities of from about 1.1 to about 2.0.

The filler material can be notably selected from the group consisting of inorganic filler [material (I)] and carbonaceous filler material [material (C)].

The filler may have various morphologies, for example isotropic, including spherical shapes, platy or acicular.

The fillers may therefore be notably in the form of fibers, hollow or solid pellets, powders.

Within the context of the present invention, the expressions “inorganic filler material” and “material (I)” are intended to denote all those materials which essentially consist of inorganic salts or oxides.

The choice of the inorganic filler material is not particularly critical; it is generally understood that material (I) which remain inert during well bore operations are preferred. Non limitative examples of materials (I) which can be used are notably inorganic oxides, inorganic carbonates, inorganic silicates, inorganic sulphates, nitrides, carbides and the like. Inorganic oxides are generally selected among Si, Zr, and Ti oxides and mixed oxides comprising these metals in combination with one or more other metal(s) or non metal(s); e.g. silica/silicon oxides (including natural and synthetic oxides), alumina/aluminium oxides (including natural and synthetic oxides), zirconia/zirconium oxides (including natural and synthetic oxides), zirconates, glass, kaolinite, talc, mica, wollastonite, diatoms, and the like. Inorganic carbonates are typically selected from the group consisting of alkaline and alkaline earth metal carbonates, e.g. K, Ca, Mg, Ba, Sr carbonates. Among nitrides and carbides, silicon nitride and silicon carbide can be mentioned. Inorganic silicates include notably alumino-silicates (including natural and synthetic clays), calcium silicate, cement and the like. Inorganic sulphates are generally selected among alkaline and alkaline earth metal sulphates, including Ca, Mg, Ba, Sr sulphates.

Among materials (I), according to a first embodiment, silicon oxides have been found as providing good results; among silicon oxides, fly ash that has been shown to perform particularly advantageously in the particulate composition.

Within the context of the present invention, the expressions “fly ash” refers to a finely divided residue resulting from the combustion of carbonaceous material, such as ground or powdered coal, and generally carried by generated flue gases.

Fly ash is generally captured by electrostatic precipitators or other particle filtration equipments before the flue gases reach the chimneys of coal-fired power plants, and together with bottom ash removed from the bottom of the furnace is in this case jointly known as coal ash. Depending upon the source and makeup of the coal being burned, the components of fly ash vary considerably, but all fly ash includes substantial amounts of silicon dioxide (SiO₂) (both amorphous and crystalline) and calcium oxide (CaO), both being endemic ingredients in many coal-bearing rock strata, but also generally aluminium oxide (Al₂O₃) and iron oxide (Fe₂O₃).

One preferred type of fly ash is ASTM class F fly ash. In other embodiments of the present invention, the combustion product may comprise “bottom ash.” Bottom ash, as referred to herein, refers to a finely divided residue resulting from the combustion of carbonaceous material that generally accumulates on the floor of an incinerator. Another preferred type of fly ash is a high-lime (ASTM class C) fly ash produced from combustion of low-sulfur, sub-bituminous coal. Low carbon, high calcium content and self-cementitious properties characterize this type of fly ash. Generally, ASTM class C fly ash contains more fine and less coarse particles than low-lime (ASTM class F) fly ash, is composed of 20 to 30 weight percent crystalline compounds with the remainder being amorphous, glassy materials, and comprises spheroidal particles having a typical particle size distribution from 1 to 150 microns diameter, but preferably particles with sizes 65 micron and larger. In certain preferred embodiments of the present invention when using fly ash as the inorganic filler material, after sampling the fly ash, the moisture content of the fly ash preferably is maintained at less than 1 percent by, e.g., oven drying the fly ash to reduce hydration and pozzolanic reactions, prior to composite production. Regardless of the fly ash chosen, it preferably comprises substantially spherical particles.

Among materials (I), according to a second embodiment, the filler material is a material (I) selected from the group consisting of glass fibers. Glass fibers fillers may have a round cross-section or a non-circular cross-section (“flat glass fibers”), including oval, elliptical or rectangular. The glass fibers may be added as endless fibers or as chopped glass fibers. The glass fibers have generally an equivalent diameter of 5 to 20 preferably of 5 to 15 μm and more preferably of 5 to 10 μm. E glass fibers are especially used as chopped glass fibers, or as endless fibers (roving). However, all other glass fiber types, such as A, C, D, M, S, R glass fibers or any mixtures thereof or mixtures with E glass fibers may be used.

Within the context of the present invention, the expressions “carbonaceous filler material” and “material (C)” are intended to denote all those materials which essentially consist of carbon. It is understood that said carbonaceous materials might comprise reduced amounts of other elements (e.g. H, O, N, S . . . ), without this significantly affecting the physico-chemical properties of the carbonaceous material itself.

Among carbonaceous materials suitable for the purposes of the invention, mention can be notably made of carbon black, carbon fibers, diamond like carbon, graphite, fullerenes, including spherical fullerenes and carbon nanotubes.

The expression “carbon black” is intended to denote powdered form of highly dispersed, amorphous elemental carbon. Carbon black is generally available as a finely divided, colloidal material in the form of spheres and their fused aggregates. Types of carbon black are characterized by the size distribution of the primary particles, and the degree of their aggregation and agglomeration. Average primary particle diameters of carbon black typically range from 10 to 400 nm, while average aggregate diameters range from 100 to 800 nm. Carbon black can be manufactured under controlled conditions whereas soot is randomly formed, and they can be distinguished on the basis of tar, ash content and impurities. Carbon black can be also made by the controlled vapor-phase pyrolysis and/or thermal cracking of hydrocarbon mixtures such as heavy petroleum distillates and residual oils, coal-tar products, natural gas and acetylene. The expression “carbon black” thus embraces notably acetylene black, channel black, furnace black, lamp black, thermal black. Acetylene black is the type of carbon black derived from the burning of acetylene. Channel black is made by impinging gas flames against steel plates or channel irons (from which the name is derived), from which the deposit is scraped at intervals. Furnace black is the term generally applied to carbon black made in a refractory-lined furnace. Lamp black, the properties of which are markedly different from other carbon blacks, is made by burning heavy oils or other carbonaceous materials in closed systems equipped with settling chambers for collecting the solids. Thermal black is produced by passing natural gas through a heated brick checkerwork where it thermally cracks to form a relatively coarse carbon black. Over 90% of all carbon black produced today is furnace black. Carbon black is available commercially from numerous suppliers such as Cabot Corporation.

The expression “Diamond-like carbon (DLC)”, as used therein, encompasses all forms of amorphous carbon materials containing significant amounts (e.g. >50%) of spa hybridized carbon atoms. As a result, DLC materials typically display some of the unique properties of natural diamond. It is well-known that natural diamond can be found in two crystalline polytypes. The usual one has its carbon atoms arranged in a cubic lattice, while the very rare one (lonsdaleite) has a hexagonal lattice. In DLC materials, these polytypes are typically present ways at the nanoscale level of structure, so that DLC materials are available that at the same time are amorphous, flexible, and yet purely sp³ bonded “diamond”. The hardest, strongest, and slickest is such a mixture, known as tetrahedral amorphous carbon, or ta-C, which can be considered to be the “pure” form of DLC, since it consists only of sp³ bonded carbon atoms. Fillers such as hydrogen, graphitic sp² carbon, and metals are generally used in the other forms of DLC to reduce production expenses, but at the cost of decreasing its mechanical properties.

The term “graphite” is intended to denote the low density allotrope of carbon (C), whose structure consists of layered hexagonal rings of sp²-hybridised carbon atoms. These layers are notably held together by weak Van der Waals type forces resulting from the interactions between clouds of delocalised p electrons from each of the layers.

The term “fullerene” encompasses carbon molecules (notably different from graphite and diamond), consisting of a spherical, ellipsoid, or cylindrical arrangement of carbon atoms bound by sp² bonds, under the form of predominant linked hexagonal rings of carbon atoms, but also pentagonal or sometimes heptagonal rings that prevent said assembly from being planar.

Spherical fullerenes are often called “buckyballs” whereas cylindrical fullerenes are known as “buckytubes”, or “carbon nanotubes (CNT)”.

Either single-walled carbon nanotubes (SWCN) or multi-walled carbon nanotubes (MWCN) can be used to the purpose of the invention. CNTs may have diameters ranging from about 0.6 nanometers (nm) for a single-wall carbon nanotube (SWNT) up to 3 nm, 5 nm, 10 nm, 30 nm, 60 nm or 100 nm for a SWNT or a multiple-wall carbon nanotube (MWNT). A CNT may range in length from 50 nm up to 1 millimeter (mm), 1 centimeter (cm), 3 cm, 5 cm, or greater. A CNT will typically have an aspect ratio of the elongated axis to the other dimensions greater than about 10. In general, the aspect ratio is between 10 and 2000.

The specific gravity and crush strength of the proppant particulates of the present invention may be influenced, in part, by adjusting, inter alia, the relative percentage of polymer (P) to filler material. The relative amounts of filler material and thermoplastic material may be adjusted by one skilled in the art to tailor the final proppant particulate to achieve desirable physical properties, including particle density, bulk density, crush strength, agility, etc.

The filler material of the present invention may be any micro-sized particle that is compatible with the polymer (P) and with the ultimate use of the particulate.

The composite proppant particulates of the present invention may be made by combining the polymer (P) and the filler material into a uniform mixture, and then forming particulates having a desired shape and suitable properties (such as crush resistance and specific gravity) for use in subterranean applications. In one embodiment, the polymer (P) and the filler material are combined by mixing the chosen polymer (P) with the chosen filler material in a suitable container such that the filler material becomes substantially dispersed throughout the polymer (P), and then forming the composite into substantially spherical particles suitable for use in subterranean operations. Operations include any subterranean treatment operation wherein proppant particulates may be used, which include, but are not limited to, fracturing and gravel packing operations. The filler material may be added to the polymer (P) while it is in the molten state (be it above melting point and/or glass transition temperature), may be added to the polymer (P) after it has been melted so long as the distribution of the filler material throughout the polymer (P) is substantially uniform.

As said, one other embodiment of the invention provides a method of forming the proppant particulates of the invention comprising the step of forming a mixture comprising polymer (P) and all optional ingredients, including notably the filler material, as above detailed; and forming the mixture into proppant particulates suitable for use in subterranean environment.

Suitable processes for forming the mixture into proppant particulates suitable for use in a subterranean operation are well known in the art. One such method that may be used to produce the proppant particulates of the present invention involves pouring the mixture comprising polymer (P) and all optional ingredients, including notably the filler material, onto a slanted, rotating table to create substantially uniform, and substantially spherical proppant particulates. The size of the particulate may be influenced, inter alia, by affecting the speed of the table's rotation and the angle of the table's slant. In another method, the mixture comprising polymer (P) and all optional ingredients, including notably the filler material may be extruded through a molding device with multiple openings to form strands or rod shape structures. The extruded strands may be then chopped, cut, or crushed into smaller fragments before sieving to desirable size.

The term “spherical” is used herein to designate particulates having an average ratio of minimum diameter to maximum diameter of about 0.7 or greater. The average size of the proppant particulates of the present invention is generally comprised between 100 μm and 3 mm, preferably between 250 μm and 2 mm.

Typically, a larger proppant size will result in greater permeability at lower closure stresses. As the closure stress is increased, the effect of particle size on conductivity is reduced due to increased crushing of the larger proppant sizes.

Proppant particulates having sizes of 12/18 mesh (from 1.19 to 1.68 mm), 16/20 mesh (from 841 μm to 1.0 mm), 20/40 mesh (from 420 to 841 μm), 30/50 mesh (297 to 595 μm) have been used with success. Having such a particle size allows the particulates to be useful in sand control operations and production enhancing operations. One skilled in the art with the benefit of this disclosure will recognize the appropriate size for a given application. Once formed, the proppant particulates may be crushed, chopped, or otherwise manipulated to form smaller-sized particulates if desired. Moreover, the particulates (whether or not they have been manipulated into smaller-sized particulates) may be sieved to obtain a more uniform particle size distribution.

Many subterranean treatments involve suspending proppant particulates in a treatment fluid and carrying those proppant particulates into the subterranean formation for a desired purpose. Generally, the treatment fluid should exhibit a sufficient viscosity that is high enough to neutrally suspend the proppant particulates. Thanks to their inherent lightweight, generally, the composite proppant particulates of the present invention allow for the use of relatively lower-viscosity servicing fluids. In one embodiment of the present invention, a treatment fluid comprising a hydrocarbon or water carrier fluid component and at least a portion of the proppant particulates of the present invention is pumped into a subterranean formation. In some embodiments, these proppant particulates may be dropped from the fluid into a desired zone in the subterranean formation or a well bore penetrating the subterranean formation. In some fracturing embodiments, the proppant particulates may be dropped in at least one fracture to aid in maintaining the integrity of that fracture. In a gravel packing embodiment, the proppant particulates may be dropped out of the fluid in a manner so as to create a gravel pack that is in or neighbors a chosen zone in the subterranean formation. In some embodiments of the methods of the present invention, the proppant particulates may be included in a treatment fluid in an amount from about 0.01 pounds per gallon to about 25 pounds per gallon.

One embodiment of a method of the present invention provides an improved method of treating a subterranean formation using a treatment fluid comprising a hydrocarbon or water carrier fluid and proppant particulates of the present invention suspended therein. Such embodiments of the present invention provide methods of treating a subterranean formation comprising the steps of providing a servicing fluid comprising a fluid component and proppant particulates as above detailed; placing the servicing fluid into the subterranean formation at a pressure sufficient to create or enhance at least one fracture therein.

Still another method of the present invention provides an improved method of hydraulic fracturing using the proppant particulates as above detailed. Some hydraulic fracturing methods of present invention, comprise the steps of providing a fracturing fluid comprising a fluid component and proppant particulates as above detailed; placing the fracturing fluid into the subterranean formation at a pressure sufficient to create or enhance at least one fracture therein.

Another method of the present invention provides an improved method of installing a gravel pack in or neighbouring a chosen zone in a subterranean formation comprising the steps of providing a gravel pack fluid comprising a fluid component and proppant particulates as above detailed; and, introducing the gravel pack composition to the well bore such that the particulates form a gravel pack substantially adjacent to the chosen zone in the subterranean formation.

The invention will be now explained in more details with reference to the following examples, whose purpose is merely illustrative and not intended to limit the scope of the invention.

### Raw Materials

ZYTEL® 101 PA is a Nylon 6,6 aliphatic polyamide, made from adipic acid and hexamethylene diamine, and having a T_{g} of 60° C. (PA 6,6, hereinafter).

ZYTEL® 7063 PA is a compound comprising PA 6,6, as above detailed and 33% wt of glass fibers.

AMODEL® 1007 PPA is a polyphthalamide resins made from terephthalic and isophthalic acids, and having a T_{g} of 130° C. (A-1007, hereinafter).

AMODEL® A-4000 PPA is a polyphthalamide resin made from terephthalic and adipic acids, and having a T_{g} of 98° C. (A-4000, hereinafter).

AMODEL® 1004 PPA is a polyphthalamide resins made from terephthalic and isophthalic acids, and having a T_{g} of 123° C. (A-1004, hereinafter).

AMODEL® A-1933 HSL BK 328 is a compound comprising A-1007 PPA, as above specified, and glass fibers (33% wt).

AMODEL® AS-4133 HS BK 324 is a compound comprising A-4000 PPA, as above specified, and glass fibers (33% wt).

AMODEL® AS-1933 HS BK 324 is a compound comprising A-1004 PPA, as above specified, glass fibers (34.5% wt) and C-black (1.5% wt).

UDEL® P-1700 PSU is a polysulfone having a T_{g} of 185° C., and a HDT of 174° C. (at 1.8 MPa, according to ASTM D648) (PSU, hereinafter).

UDEL® GF-130 PSU is a compound comprising UDEL® P-3703 polysulfone having a HDT of 174° C. (at 1.8 MPa, according to ASTM D648), and glass fibers (30% wt).

RADEL® R-5000 NT PPSU is a polyphenylsulfone having a T_{g} of 220° C. (PPSU, hereinafter).

### Compression Strength Determinations

Compression strength was determined according to ASTM D695 standard, using the following equipment and in above detailed conditions:
Instron compressive load cell with at least 6,000 pounds capability
Environment: Testing done at following temperatures: 23° C., 100° C., 125° C., 165° C.
Metal jig—machine with diameter of 0.5 inch into flat blind hole with a depth of ¼ inch. The plate was thick to prevent deflection when load applied. A dowel pin that fits into the holes with minimum clearance to prevent tilting was used. Total clearance was no more than 0.004 inch.

One set of pellets from each material was boiled in water for approximately 48 hours; Sample dimensions were measured and each pellet was setup in jig; initial depth was measured to where dowel contacted pellet without compression. Load was applied to individual pellets from each material submitted to test. Continuous pressure was applied until pellet crushed. The total deflection was recorded at specific points and load calculated at each deflection point. Load was applied for each material at each temperature setting of 23° C., 100° C., 125° C. and 165° C.

Results are summarized in Table 1 for unfilled materials and in Table 2 for filled compounds.

TABLE 1

Compression strength in psi
Temperature (° C.)

| | 23 | 100 | 125 | 165 |
|---|---|---|---|---|
| PA 6,6 | 31 107 | 14 888 | 13 130 | 13 823 |
| A-4000 | 20 917 | 16 679 | 13 381 | 11 841 |
| A-1007 | 39 537 | 20 562 | 15 468 | 7 650 |
| PSU | 63 168 | 54 870 | 49 882 | 30 913 |
| PPSU | 36 108 | 33 651 | 32 166 | 24 572 |

As nicely demonstrated by data provided herein above, only materials possessing a T_{g} of 120° C. or above are able to maintain, in unfilled status, compression strength of at least 20 kpsi at 100° C. and of at least 15 kpsi at 125° C., temperatures which might be often encountered in subterranean operations; as a consequence, only proppant particulates made from such materials having a T_{g} of 120° C. or above will maintain their performances in subterranean formation operations.

TABLE 2

| | Compression strength in psi | | | |
|---|---|---|---|---|
| | Temperature (° C.) | | | |
| | 23 | 100 | 125 | 165 |
| ZYTEL ® 7063 PA | 62 035 | 51 696 | 46 930 | 43 147 |
| AS-4133 HS BK 324 | 76 916 | 65 800 | 34 448 | 35 682 |
| A-1933 HSL BK 328 | 67 388 | 67 003 | 65 649 | 55 117 |

Same trend can also be seen for corresponding filled compounds; when the base resin has a T_{g} of below 120° C. (see ZYTEL® 7063 PA and AS-4133 HS BK 324), compression strength dramatically decrease to unacceptable values at around 125° C.; on the contrary suitable values of compression strengths are maintained at temperatures of above 100° C. for filled compounds particulate wherein the base polymer has a T_{g} of above 120° C.

1. Proppant particulates comprising at least one aromatic polycondensation polymer [polymer (P)] having:
a glass transition temperature (T_{g}) of at least 120° C. when measured according to ASTM 3418, and/or
a heat deflection temperature (HDT) of above 85° C. under a load of 1.82 MPa when measured according to ASTM D648.

2. The proppant particulates according to claim 1, wherein the polymer (P) is selected from the group consisting of aromatic polyimides (PI) including polyester-imides (PEI) and polyamide-imides (PAI), polyaryletherketones (PAEK) including polyetheretherketone (PEEK) and polyetherketoneketone (PEKK), liquid crystal polymers (LCP), semi-aromatic polyamides (PA) including polyamides derived from aromatic dicarboxylic acids (PPA) and polyamides derived from aromatic diamines (PXA), and aromatic sulfone polymers (SP).

3. The proppant particulates according to claim 2, wherein the polymer (P) is an aromatic polyimide (PI) comprising recurring units (R_{PI}), wherein more than 50% moles of said recurring units comprise at least one aromatic ring and at least one imide group having formula 1A or in its amic acid form having formula 1B:

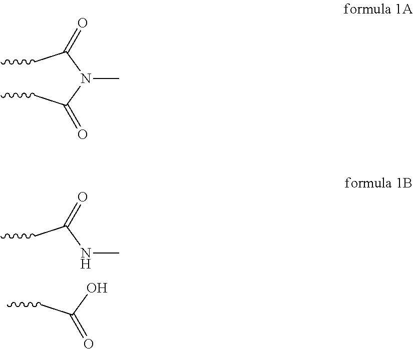

4. The proppant particulates according to claim 2, wherein the polymer (P) is an aromatic polyamide-imide (PAI) comprising more than 50% moles of recurring units (R_{PAI}), wherein said recurring units (R_{PAI}) comprise at least one aromatic ring and at least one imide group or in its amic acid form, and at least one amide group which is not included in the amic acid form of an imide group, wherein said recurring units (R_{PAI}) are selected from the group consisting of: 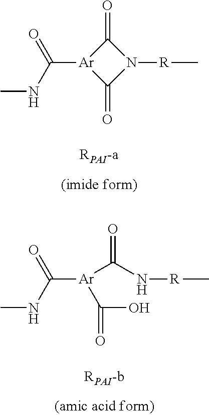
wherein the Ar is a trivalent aromatic group selected from the group consisting of: 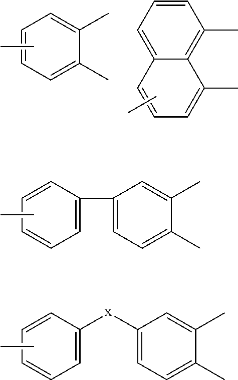
and
corresponding optionally substituted structures, wherein the X is —O—, —C(O)—, —CH₂—, —C(CF₃)₂—, or —(CF₂)ₙ—, the n is an integer from 1 to 5;
wherein the R is a divalent aromatic group selected from the group consisting of: 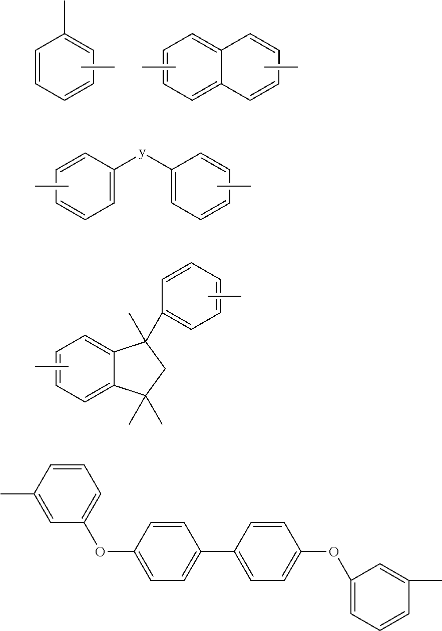
and
corresponding optionally substituted structures, wherein the Y being —O—, —S—, —SO₂—, —CH₂—, —C(O)—, —C(CF₃)₂—, —(CF₂)ₙ, the n being an integer from 0 to 5.

5. The proppant particulates according to claim 2, wherein said polymer (P) is a polyaryletherketone (PAEK) comprising recurring units (R_{PAEK}), wherein more than 50% moles of said recurring units comprise a Ar—C(O)—Ar′ group, with Ar and Ar′, equal to or different from each other, being aromatic groups, wherein said recurring units (R_{PAEK}) are selected from the group consisting of formulae (J-A) to (J-O): 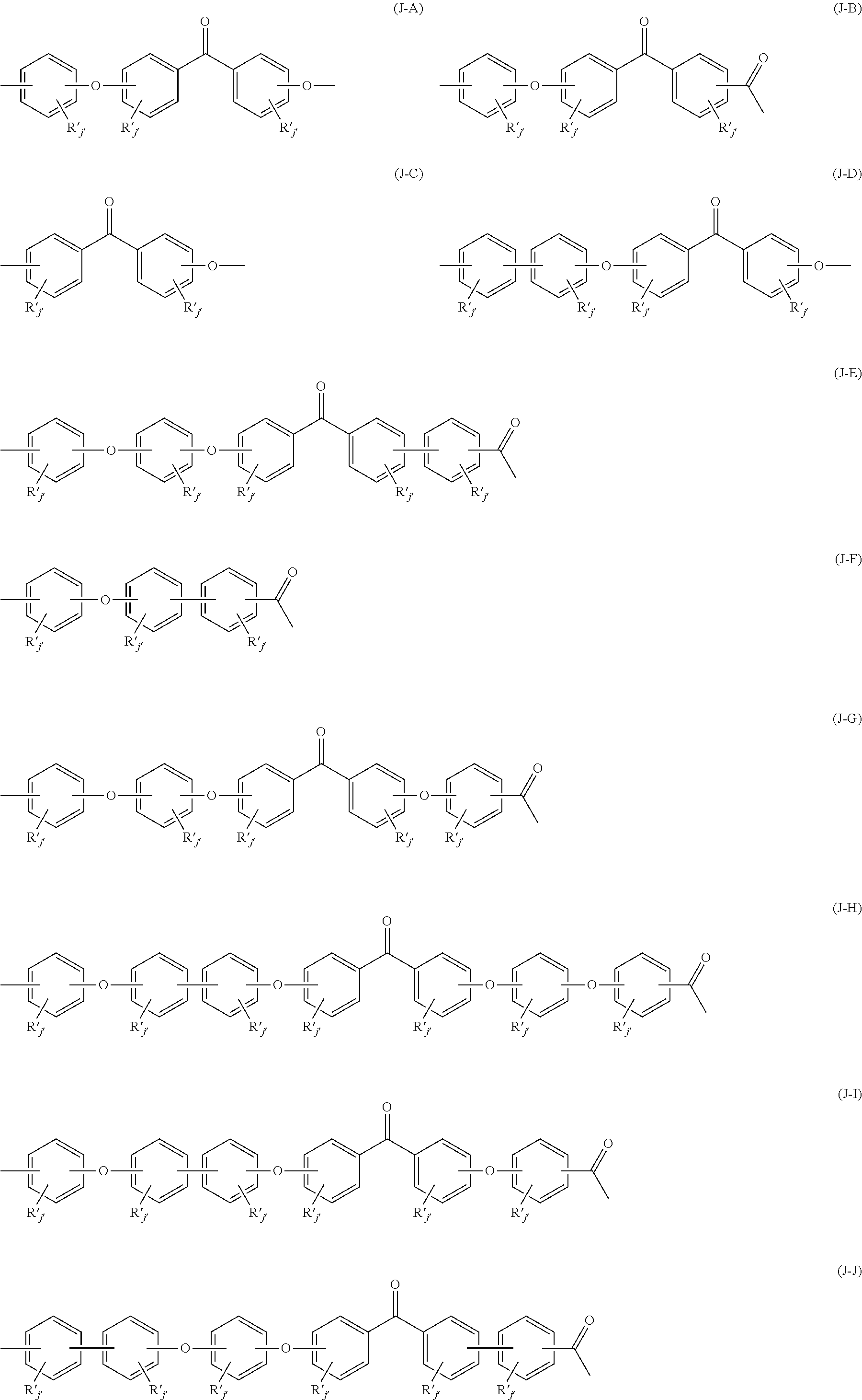 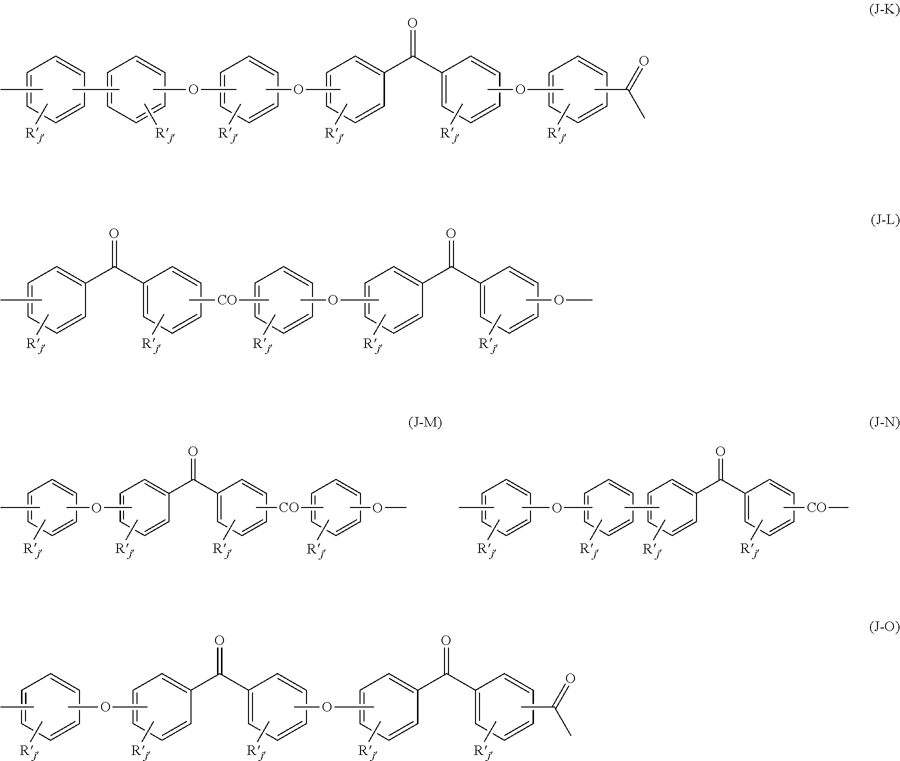
wherein:
each of said R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
said j′ is zero or is an integer from 0 to 4.

6. The proppant particulates according to claim 2, wherein said polymer (P) is a liquid crystal polymer (LCP) selected from fully aromatic liquid crystalline polyesters comprising recurring units derived from
1) a polycondensation reaction of:
an aromatic acid component [monomer (AA)] comprising one or more than one aromatic dicarboxylic acid or derivative thereof, wherein said monomer (AA) is selected from the group consisting of phthalic acids, naphthalene dicarboxylic acids and pyridine dicarboxylic acids, and corresponding substituted counterparts; and
a dihydroxyl component [monomer (BB)] comprising one or more than one di-hydroxyl aromatic derivative or derivative thereof, wherein said monomer (BB) is selected from the group consisting of biphenol, 4,4′-dihydroxy-1,1-biphenyl, and corresponding substituted counterparts; and/or from
2) a polycondensation of one or more aromatic hydroxyl-substituted carboxylic acid or the derivatives thereof [monomer (AB)], wherein said monomer (AB) is selected from the group consisting of 4-hydroxybenzoic acid, 6-hydroxy-é-naphthoic acids, and corresponding substituted counterparts,
wherein said monomers (AB) can be polymerized alone or in combinations with said monomers (AA) and said (BB).

7. The proppant particulates according to claim 2, wherein said polymer (P) is an aromatic sulfone polymer (SP) comprising recurring units (Rₛₚ), wherein at least 50% moles of the recurring units thereof comprise at least one group of formula (SP):
—Ar—SO₂—Ar′—
wherein Ar and Ar′, equal to or different from each other, are aromatic groups, said recurring units (R_{SP}) complying with formula:
—Ar¹-(T′-Ar²)ₙ—O—Ar³—SO₂—[Ar⁴-(T-Ar²)ₙ—SO₂]ₘ—Ar⁵—O—
wherein:
Ar¹, Ar³, Ar³, Ar⁴, and Ar⁵, equal to or different from each other and at each occurrence, are independently a aromatic mono- or polynuclear group;
T and T′, equal to or different from each other and at each occurrence, is independently a bond or a divalent group optionally comprising one or more than one heteroatom; wherein T′ is selected from the group consisting of a bond, —CH₂—, —C(O)—, —C(CH₃)₂—, —C(CF₃)₂—, —C(═CCl₂)—, —SO₂—, —C(CH₃)(CH₂CH₂COOH)—, and a group of formula: 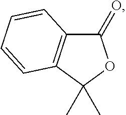
and
wherein T is selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula: 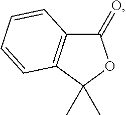
and
n and m, equal to or different from each other, are independently zero or an integer of 1 to 5.

8. The proppant particulates according to claim 2, wherein said polymer (P) is an aromatic polyamide polymer (PA) comprising more than 35 mol % of aromatic recurring units comprising at least one amide group (R_{PA}).

9. The proppant particulates according to claim 8, wherein the recurring units (R_{PA}) are recurring units (R_{PPA}) deriving from
1) a polycondensation reaction of:
(i-1) a dicarboxylic acid component [acid component (AA)], wherein said acid component (AA) comprises at least one aromatic dicarboxylic acid or derivative thereof [acid (AR)]; and
(i-2) a diamine component [amine component (NN)] comprising at least one aliphatic alkylene-diamine [amine (NN)],
and/or from
2) a polycondensation reaction of:
(i-3) an aromatic aminoacid component [aminoacid component (ArN)], comprising at least one aromatic carboxylic acid comprising at least one amino group, and
wherein the acid component (AA) may comprise in addition to said at least one aromatic dicarboxylic acid [acid (AR)], one or more than one non-aromatic dicarboxylic acid [acid (AL)].

10. The proppant particulates according to claim 9, wherein the polyamide (PA) comprises recurring units (R_{PPA}) selected from the group consisting of:
polyamides, obtained by polycondensation of an acid component (AA) and an amine component (NN), wherein the acid component (AA) comprises phthalic acids (PA) including particular acid (TA) and acid (OA), alone or in combination, and is substantially free from acid (AL), and wherein the amine component (NN) consists of one or more than one aliphatic alkylene diamine comprising 6 carbon atoms or less;
polyamides, wherein the acid component (AA) comprises at least one naphthalene dicarboxylic acid, and wherein the amount of acid(s) (AL) is less than 10% moles, with respect to all acids of the acid component (AA);
polyamides, wherein the amine component (NN) comprises at least one aromatic diamine (NN_{Ar}) selected from the group consisting of m-phenylene diamine (MPD), p-phenylene diamine (PPD), 3,4′-diaminodiphenyl ether (3,4′-ODA), 4,4′-diaminodiphenyl ether (4,4′-ODA), m-xylylenediamine (MXDA), and p-xylylenediamine (PXDA), said aromatic diamine (NN_{Ar}) being comprised in an amount of at least 5% moles, with respect to all amines of the amine component (NN);
polyamides, wherein the amine component (NN) comprises at least one cycloaliphatic diamine (NN_{Cy}) selected from 1,3-BAMC, 1,4-BAMC, PACM, bis(4-amino-3-methylcyclohexyl)methane, isophoronediamine, said cycloaliphatic diamine (NN_{Cy}) being comprised in an amount of at least 5% moles, with respect to all amines of the amine component (NN);
polyamides, wherein the amine component (NN) comprises at least one aliphatic alkylene-diamine selected from the group consisting of 1,2-diamino-1-butylethane, 1,5-diamino-2-methylpentane (2-MPMD), and 1,3-pentanediamine (DAMP), in an amount of at least 5% moles, with respect to all amines of the amine component (NN).

11. The proppant particulates according to claim 8, wherein the recurring units (R_{PA}) are recurring units (R_{PXA}) deriving from a polycondensation reaction of:
(i-1) a dicarboxylic acid component [acid component (AA′)], wherein said acid component (AA′) comprises at least one non-aromatic dicarboxylic acid or derivative thereof [acid (AL′)]; and
(i-2) a diamine component [amine component (NN′)] comprising at least one aromatic diamine [amine (NN_{Ar})], and
wherein the amine component (NN′) may comprise in addition to said at least one amine (NN_{Ar}), one or more than one non-aromatic diamine [amine (NN_{AL})].

12. The proppant particulates according to claim 11, wherein the polyamide (PA) comprising recurring units (R_{PXA}) is selected from the group consisting of
polyamides obtained by a polycondensation of an acid component (AA′) and an amine component (NN′), wherein the amount of amine (NN_{AL}), if present, in the amine component (NN′) is of at most 20% moles, with respect to the total moles of amine component (NN′);
polyamides, wherein the amine component (NN′);
comprises at least one cycloaliphatic diamine (NN_{Cy}) selected from 1,3-BAMC, 1,4-BAMC, PACM, bis(4-amino-3-methylcyclohexyl)methane, isophoronediamine, said cycloaliphatic diamine (NN_{Cy}) being comprised in an amount of at least 5% moles, with respect to all amines of the amine component (NN′); and
polyamides wherein the amine component (NN′) comprises at least one aliphatic alkylene-diamine selected from the group consisting of 1,2-diamino-1-butylethane, 1,5-diamino-2-methylpentane (2-MPMD), and 1,3-pentanediamine (DAMP), in an amount of at least 5% moles, with respect to all amines of the amine component (NN′).

13. The proppant particulates according to claim 1, further comprising, in addition to said polymer (P), from 5% to 70% of filler material by weight of the overall proppant particulate.

14. The proppant particulates according to claim 13, wherein the filler material is selected from silicon oxides, glass fibers, carbon black, carbon fibers, diamond like carbon, graphite, fullerenes and carbon nanotubes.

15. The proppant particulates according to claim 1, wherein said proppant particulates have sizes of 12/18 mesh (from 1.19 to 1.68 mm), 16/20 mesh (from 841 μm to 1.0 mm), 20/40 mesh (from 420 to 841 μm) or 30/50 mesh (297 to 595 μm).

16. A method of treating or fracturing a subterranean formation comprising the steps of providing a servicing or fracturing fluid comprising a fluid component and proppant particulates according to claim 1; placing the servicing or fracturing fluid into the subterranean formation at a pressure sufficient to create or enhance at least one fracture therein.

17. A method of installing a gravel pack in or neighboring a chosen zone in a subterranean formation comprising the steps of providing a gravel pack fluid comprising a fluid component and proppant particulates according to claim 1; and, introducing the gravel pack composition to the well bore in such that the particulates form a gravel pack substantially adjacent to the chosen zone in the subterranean formation.
